(19) United States
(12) Patent Application Publication
(10) Pub. No.: US 2014/0279510 A1
(43) Pub. Date: Sep. 18, 2014

(54) Direct Deposit Money Transfer

(71) Applicant: MONEYGRAM INTERNATIONAL, INC., Minneapolis, MN (US)

(72) Inventors: Michael William Ebeling, Shakopee, MN (US); Michael E. Hermansen, Shorewood, MN (US)

(73) Assignee: Moneygram International, Inc., Minneapolis, MN (US)

(21) Appl. No.: 13/829,552

(22) Filed: Mar. 14, 2013

(51) Int. Cl. G06Q 20/10

(52) U.S. Cl. CPC G06Q 20/10
USPC 705/44; 705/39

(57) ABSTRACT

Systems, devices and methods which provide for funding money transfer transactions via a direct deposit of transaction funds from a sender are provided herein. In some embodiments an account may be provided by a money transfer service to a sending party which may receive funds from a direct deposit. A money transfer transaction may be staged, or in some embodiments pre-staged, by a sending party and may be completed upon receiving the transaction funds via a direct deposit.

### TECHNICAL FIELD

The present application relates to money transfer transactions. More specifically, the present application relates to implementing money transfer transactions which are funded via direct deposit.

### BACKGROUND

Generally speaking, money transfers are real-time transactions in that a transaction begins when a sender initiates the transaction at the time the money is to be sent to a receiving party. For example, a money transfer may be utilized in an emergency setting such as when a receiving party has an immediate need for funds. In such a transaction, a sender initiates a money transfer transaction with a money transfer service, such as with a local agent located within a MoneyGram® location. When the transaction information is gathered and the structure of the transaction is finalized, the sender provides the funds to a money transfer agent at or before the time that the funds of the transaction are actually transferred.

Once the funds are received at the time of the transaction, the agent may then provide a transaction code or some other form of transaction identifier to the sender. The sender will then provide the transaction code or identifier to the receiver. With this code the receiver may enter an agent location and complete the transaction and receive the transferred funds.

Many steps have been taken in order to increase the efficiency and availability of money transfer transactions. For example, efforts have been made to streamline the data entry which defines the transaction, to make it easier to properly identify transacting parties, and to create alternative means to fund transactions (e.g. pre-approved credit, payment plans, etc.). However, while such efforts provide for various advantages, different methods may prove to be more useful in various circumstances.

### BRIEF SUMMARY

The present application provides for systems, devices and methods which provide for funding money transfer transactions via a direct deposit of transaction funds from a sender. In some embodiments such transactions may be pre-staged by a sending party and completed upon receiving the transaction funds via a direct deposit. Embodiments may provide for multiple efficiencies, which are described in more detail below, which are made possible as a result of the use of direct deposit funds.

In one embodiment a method, computer program product and/or apparatus for conducting a money transfer transaction is provided. This embodiment may include establishing, by a money transfer service server, an account configured to receive funds from a direct deposit transaction. With the account established, funds from a direct deposit transaction may be received at the money transfer service server. Such funds may be utilized to fund a money transfer transaction.

In another embodiment a method, computer program product and/or apparatus for conducting a money transfer transaction may include staging a money transfer transaction at a processing device of a money transfer service upon receiving transaction details from a sending party. Additionally, such an embodiment may include receiving funds belonging to the sending party from at least one direct deposit transaction. The received funds may be directed to an account corresponding to the sending party which has been established by the money transfer service. Further, the staged money transfer transaction may be funded with the funds from the at least one direct deposit transaction.

The foregoing has outlined rather broadly the features and technical advantages of the present invention in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of embodiments described herein, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present embodiments.

### BRIEF DESCRIPTION OF THE DRAWINGS

For a more complete understanding, reference is now made to the following descriptions taken in conjunction with the accompanying drawings, in which:

FIG. 1 illustrates a system for implementing a money transfer transaction in accordance with an embodiment of the present application;

FIG. 2 illustrates an example operational flow diagram of a direct deposit money transfer process in accordance with an embodiment of the present application;

FIG. 3 illustrates a method for performing a money transfer in accordance with an embodiment of the present application; and

FIG. 4 illustrates a method for performing a money transfer in accordance with an embodiment of the present application.

### DETAILED DESCRIPTION

FIG. 1 illustrates a system 100 for implementing a money transfer transaction in accordance with an embodiment of the present application. System 100 may include one or more central servers 101, agent devices 102, user devices 103 and third party financial servers 104. Each of these devices may include processing, storage and communications capabilities and may be in communication with one another over communications network 105.

Central server 101 may correspond to a central or parent money transfer service which administers money transfer transactions between agent devices 102a-102n, or between one or more user devices 103a-103n and/or one or more agent devices 102a-n, etc. Furthermore, central server 101 may administer a user account for a sending party of a money transfer transaction and may be configured to allow for the transfer of funds to a receiving party (e.g. an individual, business receiving a bill payment, and the like).

In one embodiments, central server 101 may comprise multiple servers that may be commonly located or distributed geographically. Additionally, the administration of a money transfer transaction and/or the configuration of one or more agent devices 102a-102n may be implemented by a single central server 101, or by using multiple processing resources of a plurality of servers.

Agent devices 102a-102n may correspond to computer systems within a money transfer agent location. Agent devices 102a-102n could include special purpose computers programmed to implement steps described herein, or could be conventional processing devices configured to run software which facilitates the described money transfer transactions. For example, such devices may be computer systems which are accessible by an agent at an agent location, may be automated machines such as an Automated Teller Machine (ATM), and the like. Agent devices 102a-102n may be located throughout the world and one or more devices may be utilized within a single money transfer transaction. Agent devices 102a-102n are configured to send and receive information over communication network 105. In some embodiments, agent devices 102a-102n may also have a direct connection with one or more devices of system 100 such as third party financial server 104, and central server 101. Agent devices 102a-102n may be configured to transmit and receive transaction information between respective devices of system 100.

User devices 103a-103n may be any type of device which would facilitate the exchange of information within system 100. For example, user devices 103a-103n may include computer systems, tablet devices, mobile telephones, and the like. Different embodiments may utilize different aspects of the types of client devices. For example, mobile telephones and tablet devices may have the ability to connect with various communications networks and may have different application execution capabilities. User devices 103a-103n may be utilized before, during and after a money transfer transaction in any manner to facilitate convenient and secure transactions.

For example, user device 104 may be utilized to initiate a transaction. One aspect may include a dedicated app or online interface corresponding to a money transfer service which can compile information relating to the send portion of the money transfer transaction and may in some instances accept funds for the transaction or access an account which is administered by central server 101 in order to fund a transaction. Such embodiments may fully establish the money transfer transaction and cause other portions of system 100 to function in a manner to facilitate the transaction, etc. In another embodiment, user device 104 may compile data corresponding to the send portion of the transaction and provide this information to an agent device 101 whereupon the sending party may utilize agent device 101 to finalize the transaction.

Third party financial service server 104 may function to provide funds to an account administered by central server 101. For example, third party financial service server 104 may be administered by a bank or other financial service (e.g. an employer, investment entity, etc.) which may deposit money into an account of another person or entity. For example, third party financial service server 104 may be configured to administer a direct deposit of payroll funds for an employee into an employee's account.

Communication network 105 may be a packet-switched network such as the World Wide Web, a cellular/3G/4G network, or any other network configured to facilitate communications between the various devices of FIG. 1. Additionally, communication network 105 may be combination of networks working in conjunction to allow for the communications described for the embodiments herein.

FIG. 2 illustrates an example operational flow diagram of a direct deposit money transfer process 200 in accordance with an embodiment of the present application. Where applicable, steps in process 200 may be implemented using system 100 of FIG. 1. It is noted that various steps in process 200 may be implemented in varying orders. Further, in some embodiments additional steps may be added or some steps may be omitted.

Process 200 begins with a user establishing an account with a money transfer service at 201. Such an account may be established by a user entering an agent location and providing requisite personal information, which may be entered on agent device 102, to create an account. Additionally, in some embodiments a user may provide the information using user device 103. Once established, the user's account may be administered by central server 101 which may be configured to keep an accounting of funds entering and exiting the account. The account may be provided with an account number and a routing number to facilitate direct deposit of funds.

At block 202 the user configures a direct deposit service to fund the established money transfer account. Typically, a direct deposit service will originate with an employer of the user and the direct deposit will be provided by a financial institution of the employer at the point when the user is being paid for employment. Other arrangements may be implemented where the direct deposit service is provided for by the employer or another entity. The direct deposit service may be administered by third party financial service server 104.

The user may stage a money transfer transaction which is to be funded with funds from the established account at block 203. This transaction may be staged by a user entering an agent location and utilizing agent device 102. Additionally, in some embodiments, the transaction may be staged remotely with user device 103 via a web-based program, mobile app, and the like.

At block 204, funds are received into the established account from a direct deposit. Once the funds are received, the staged money transfer transaction may be funded at 205, whereupon the funds may be sent to the receiving party. It is noted that the funds from the money transfer transaction may be deducted from the established account at this point in the transaction. Additionally, funds may be deducted upon completion of the transaction (e.g. when the receiving party receives the funds at block 207).

It is noted that, as illustrated, the money transfer transaction is pre-staged, e.g., is configured to create the transaction whereupon the transaction funds will be transferred upon receipt of the funds as a result of a direct deposit into the established account. Other embodiments may stage the transaction after the receipt of funds into the account (e.g. whether after a first deposit, second deposit, etc.). In some embodiments, a user may establish a recurring money transfer transaction which may occur at a regular period, for example, shortly after the time when a direct deposit is placed in the established account. In another embodiment, a pre-staged transaction may be planned, however, the transaction may still be configured to require an additional user's approval to fund the transaction once the user's account has adequate funds. In additional embodiments, a user may establish multiple transactions and transaction types.

Once the transaction has been funded and sent, process 200 may notify the receiving party that the money transfer transaction has been sent. This notification may come automatically from central server 101, an agent device 102 or from the sending party, e.g. utilizing user device 103. The receiving party may have their own user device 103 or financial service server which receives information regarding the transaction. This user device may be utilized to receive the transferred funds at block 207 (e.g. by providing transaction information or other identifying information which will assist in retrieving the funds). Additionally, a receiving party may enter a an agent location and initiate the reception of funds in the location using agent device 102.

Upon completion of the transaction, process 200 may include notifying the sending party that the transaction is complete at block 208. This notification may be delivered in any manner, such as by sending an email or text message to the sending party at a user device 103.

In view of exemplary systems and processes shown and described herein, methodologies that may be implemented in accordance with the disclosed subject matter will be better appreciated with reference to various functional block diagrams. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

FIG. 3 illustrates a method 300 for performing a money transfer in accordance with an embodiment of the present application. It is noted that method 300 may be implemented within one or more systems, such as system 100 described above. Method 300 includes, at block 301 establishing, by a money transfer service server, an account configured to receive funds from a direct deposit transaction. With the account established, method 300 may include, at block 302, receiving funds from a direct deposit transaction at the money transfer service server. Additionally, the money transfer transaction is funded a with the funds from the direct deposit transaction at block 303.

In accordance with more detailed embodiments it is noted that method 300 may include additional steps and features. For example, in some embodiments the money transfer transaction may be pre-staged or staged after the deposit of direct deposit funds. Each type of transaction may include advantages and convenience for the money transfer service and the parties involved in the money transfer transaction. Additionally, in some embodiments, the money transfer transaction may be funded by a plurality of direct deposit transactions. For example, in an event that a sending party desires to send a specific amount, but cannot afford to deposit the amount at one point in time, the account may compile the funds until the specific amount is reached.

FIG. 4 illustrates a method 400 for performing a money transfer in accordance with an embodiment of the present application. Method 400 may be implemented within one or more systems, such as system 100 described above. Method 400 may include, at block 401, staging a money transfer transaction at a processing device of a money transfer service upon receiving transaction details from a sending party. At block 402, method 400 may further include receiving funds belonging to the sending party from at least one direct deposit transaction. Upon receiving the funds, the funds may be directed to an account corresponding to the sending party which has been established by the money transfer service at block 403. Additionally, the money transfer transaction may be funded with the funds from the at least one direct deposit transaction at block 404.

In accordance with more detailed embodiments it is noted that method 400 may include additional steps and features. For example, in some embodiments the money transfer transaction staging may be implemented at a server which receives transaction information from a user device of the sending party, an agent device at a money transfer service location, or a combination of both. Money transfer transactions may be pre-staged or post-staged. Additionally, a money transfer transaction may be configured to be implemented in a recurring manner. For example, if a sending party makes regular transfers to a receiving party (e.g. in a circumstance where a dependent lives away from the sending party), a series of money transfer transactions may be configured to send at regular intervals such as on specific dates, each time an account has sufficient funds, etc.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method for conducting a money transfer transaction, the method comprising:
establishing, by a money transfer service server, an account configured to receive funds from a direct deposit transaction;
receiving, by the money transfer service server, funds from a direct deposit transaction; and
funding a money transfer transaction with the funds from the direct deposit transaction.

2. The method of claim 1 wherein the money transfer transaction is established prior to receiving the direct deposit funds.

3. The method of claim 1 wherein the money transfer transaction was established after receiving the direct deposit funds

4. The method of claim 1 wherein the money transfer transaction is funded after a plurality of direct deposit transactions have been received into the established account.

5. The method of claim 1 wherein establishing an account configured to receive direct deposit funds includes establishing an account number and routing number for the account.

6. The method of claim 1 further comprising receiving an authorization to send the funded money transfer transaction from a sending party of the transaction.

7. The method of claim 1 further comprising paying the transferred funds to a receiving party.

8. A method for conducting a money transfer transaction, the method comprising:
staging a money transfer transaction at a processing device of a money transfer service upon receiving transaction details from a sending party;
receiving funds belonging to the sending party from at least one direct deposit transaction;
directing the received funds to an account corresponding to the sending party which has been established by the money transfer service; and
funding the money transfer transaction with the funds from the at least one direct deposit transaction.

9. The method of claim 8 wherein the staging of the money transfer transaction is implemented at a server which receives transaction information from a user device of the sending party.

10. The method of claim 8 wherein the staging of the money transfer transaction is implemented at a server which receives transaction information from an money transfer service agent device.

11. The method of claim 8 wherein the staging of the money transfer transaction occurs prior to receiving funds from the at least one direct deposit transaction.

12. The method of claim 8 wherein the staging of the money transfer transaction occurs after receiving funds from the at least one direct deposit transaction.

13. The method of claim 8 wherein the money transfer transaction is configured to be a recurring money transfer transaction.

14. The method of claim 8 further comprising configuring the money transfer transaction to send the funds upon receiving sufficient funds in the established account.

15. The method of claim 8 further comprising paying the money transfer transaction funds to receiving party.

16. A computer program product having a non-transitory computer readable medium with code encoded thereon which, when executed causes one or more processing devices to:
establish an account configured to receive funds from a direct deposit transaction;
receive, by the money transfer service server, funds from a direct deposit transaction; and
fund a money transfer transaction with the funds from the direct deposit transaction.

17. The computer program product of claim 16 wherein the money transfer transaction is established prior to receiving the direct deposit funds.

18. The computer program product of claim 16 wherein the money transfer transaction was established after receiving the direct deposit funds

19. The computer program product of claim 16 wherein the money transfer transaction is funded after a plurality of direct deposit transactions have been received into the established account.

20. The computer program product of claim 16 wherein establishing an account configured to receive direct deposit funds includes establishing an account number and routing number for the account.

21. The computer program product of claim 16 further comprising receiving an authorization to send the funded money transfer transaction from a sending party of the transaction.

22. An apparatus configured for implementing financial transactions, the apparatus comprising:
a client computer having at least one processor and memory coupled to the at least one processor, wherein the at least one processor is configured to:
stage a money transfer transaction at a processing device of a money transfer service upon receiving transaction details from a sending party;
receive funds belonging to the sending party from at least one direct deposit transaction;
direct the received funds to an account corresponding to the sending party which has been established by the money transfer service; and
fund the money transfer transaction with the funds from the at least one direct deposit transaction.

23. The apparatus of claim 22 wherein the staging of the money transfer transaction is implemented at a server which receives transaction information from a user device of the sending party.

24. The apparatus of claim 22 wherein the staging of the money transfer transaction is implemented at a server which receives transaction information from an money transfer service agent device.

25. The apparatus of claim 22 wherein the staging of the money transfer transaction occurs prior to receiving funds from the at least one direct deposit transaction.

26. The apparatus of claim 22 wherein the staging of the money transfer transaction occurs after receiving funds from the at least one direct deposit transaction.

27. The apparatus of claim 22 wherein the money transfer transaction is configured to be a recurring money transfer transaction.

28. The apparatus of claim 22 further comprising configuring the money transfer transaction to send the funds upon receiving sufficient funds in the established account.
